(19) United States
(12) Patent Application Publication
(10) Pub. No.: US 2023/0143784 A1
(43) Pub. Date: May 11, 2023

(54) BUMPER WITH AN INTEGRATED REINFORCING PLATE

(71) Applicant: BENTELER AUTOMOBILTECHNIK GMBH, Paderborn (DE)

(72) Inventors: Andreas SCHILLER, Geseke (DE); Elmar MOLLEMEIER, Delbrueck (DE)

(21) Appl. No.: 17/980,610

(22) Filed: Nov. 4, 2022

(30) Foreign Application Priority Data
Nov. 5, 2021 (DE) 10 2021 128 844.4

(51) Int. Cl. B60R 19/18

(52) U.S. Cl. CPC B60R 19/18; B60R 2019/1806

(57) ABSTRACT

The present invention relates to a bumper crossmember 2 for a motor vehicle, which bumper crossmember 2 extends in the motor vehicle transverse direction and has a hollow profile in cross section, which hollow profile has, in particular, a rectangular cross section. A reinforcing plate 5 is inserted in a middle length portion, the depth T of the reinforcing plate 5 decreasing in the motor vehicle longitudinal direction X toward the ends of the reinforcing plate 5.

The present invention relates to a bumper crossmember for a motor vehicle according to the features in the precharacterizing clause of Claim 1.

Bumper crossmembers are known from the prior art which are coupled on the front side or on the end side to motor vehicle bodies. This usually takes place with the integration of crash boxes. A bumper crossmember of this type is usually produced from a metallic material, in particular from steel material or light metal material, and can be called a bumper, fender or crossmember.

A bumper crossmember should have a strength which is sufficient for a sufficient supporting action to be achieved, in particular, in the case of a bollard or pole test, for example. The bumper crossmember itself is therefore of as rigid configuration as possible. The motor vehicle collides with an object, and the crash boxes are deformed; here, crash energy is converted into reshaping work.

There are also bumper crossmembers, however, which should be deformed to a certain extent, without losing a residual rigidity in the process. In particular, the bumper crossmember should not buckle or collapse if a force level is exceeded, for example in the case of a bollard or pole test.

To this end, for example, WO 20 2005 3626 A1 has disclosed a bumper crossmember which has a reinforcing plate in a middle length portion. The reinforcing plate helps to stiffen the bumper crossmember in the middle region.

It is an object of the present invention to provide a bumper crossmember which has a high rigidity against bending, but at the same time dissipates crash energy by way of self-deformation in the case of a bollard or pole test, without itself buckling in the process.

The abovementioned object is achieved by a bumper crossmember for a motor vehicle with the features in Claim 1.

Advantageous design variants are the subject matter of the dependent claims.

The bumper crossmember according to invention for a motor vehicle extends in the motor vehicle transverse direction. As a rule, this is the case over a majority of the motor vehicle width. The bumper crossmember itself is manufactured from metallic material or else from a light metal material. The bumper crossmember has a hollow profile-like cross section, in particular a hollow chamber. In particular, this cross section is produced by way of a hollow profile which is open on one side, in particular a top hat profile, which is closed by way of a closing plate. The cross section is, in particular, in turn of angular, in particular rectangular configuration. An interior space of the cross section is, in particular, of angular, very particularly preferably of rectangular configuration. The bumper is fixed to a motor vehicle via crash boxes. It can therefore also be called a bumper arrangement.

According to the invention, the bumper crossmember is distinguished by the fact that a separate reinforcing plate is inserted in a middle length portion. The depth of the reinforcing plate in the motor vehicle longitudinal direction decreases toward the ends of the reinforcing plate. As a consequence, the ends of the reinforcing plate are tapered. The reinforcing plate is configured as a separate and, in particular, self-contained component. The reinforcing plate is therefore a separate component with respect to the closing plate. The reinforcing plate is likewise a separate component with respect to the crossmember, in particular the hollow profile of the crossmember.

As a result, the following advantage is surprisingly achieved according to the invention. In the case of a collision of a bollard or pole, in particular in the middle of the bumper crossmember, the bumper crossmember is pressed in arcuately or is deformed arcuately. As a result of the reinforcing plate in the cross section, the arcuate shape is retained as long as possible during the penetration. Buckling of the cross section is avoided by way of the reinforcing plate. By virtue of the fact that the ends of the reinforcing plate are then tapered, the cross section of the hollow profile of the bumper crossmember bears tightly against the ends of the reinforcing plate as a result of deformation. A buckling operation is therefore avoided for as long as possible. Targeted bending or curved deformation is therefore promoted over the longitudinal course of the crossmember during the penetration of the bollard or pole.

As a result, a reliable curved deformation of the crossmember as far as a preset load level being reached can therefore be achieved, without it having to be feared that the crossmember buckles and therefore piercing or penetrating of the bollard or pole into drive units, engines and/or also the passenger compartment which lie behind it takes place. Therefore, a high rigidity and a high residual resistance can be achieved with simultaneous controlled deformation and, as a consequence, also malleability or crash energy dissipation of the bumper crossmember. Complicated further measures for reworking of the bumper crossmember are avoided by way of simple use of a reinforcing plate with tapered ends.

In order that mounting of the reinforcing plate is possible, it is provided, in particular, that the hollow profile is configured as a top hat profile, and is closed by way of a closing plate. In a manner which points forward in the motor vehicle longitudinal direction, as a consequence, the closing plate particularly preferably has the opening of the top hat profile pointing forward, which opening is then closed by way of the closing plate. In this case, the closing plate forms the front wall of the bumper crossmember. In this way, as a result of the two-part construction of the bumper crossmember, the reinforcing plate can be inserted and the bumper crossmember can be closed by way of welding of the closing plate. To this end, in particular, the reinforcing plate is coupled, in particular welded, to the closing plate. This coupling takes place at least in the longitudinal portions, in particular in the end region of the reinforcing plates. The reinforcing plate is in turn coupled to the front wall of the bumper crossmember and bears against it here, in particular, depending on the cross-sectional contour of the closing plate itself. The tapered ends then result in a greater spacing in the installed state from the rear wall of the bumper crossmember.

In a central middle portion, the closing plate particularly preferably has a depth which corresponds to from 70% to 100%, preferably from 80% to 90% of the depth of the hollow profile of the bumper crossmember. The tapered ends then decrease in the motor vehicle longitudinal direction with the depth in such a way that, on an outer end region, they have approximately 40% or less of the depth of the cross section of the hollow profile of the bumper crossmember.

The reinforcing plate has, in particular, no direct coupling to or contact with the rear wall of the bumper crossmember. This allows it to bear tightly against it in the case of a crash and, as a consequence, allows a targeted deformation of the bumper crossmember with respect to the closing plate. As a consequence, the rear wall of the bumper crossmember can move relative to the closing plate, in particular in the motor vehicle transverse direction.

Furthermore, the reinforcing plate particularly preferably extends in the motor vehicle transverse direction over a length between 20% and 50%, preferably between 20% and 40% of the length of the bumper crossmember itself. Furthermore, the reinforcing plate particularly preferably has a profiled, in particular W-shaped contour in cross section. In particular, the three attachment points of the W-shape are arranged such that they are directed toward the front.

The closing plate is particularly preferably manufactured by way of a forming process. It can also be roll-formed or extruded. The tapering of the ends is then particularly preferably produced by way of cutting. As an alternative, the ends of the closing plate can also be tapered in their depth by way of stamping or flattening.

The reinforcing plate bears, in particular, against the front wall. The closing plate then has, by way of its tapering, a curved course about the motor vehicle vertical axis, the inner side of the curved shape being oriented toward the front in the direction of travel in each case over a front bumper crossmember or being oriented counter to the direction of travel, but always toward the outside, in the case of the rear bumper. This then corresponds to the receiving contour for a centrally colliding bollard or pole. The reinforcing plate does not therefore exhibit any initial deformation in the case of a central collision.

Furthermore, it has surprisingly been shown that the abovementioned aspect of the reinforcing plate can be improved by way of a soft zone in an upper flange and/or lower flange of the bumper crossmember. The soft zone is produced, in particular, by way of tailored properties; in particular, the material in the soft zone is of softer configuration in comparison with the remaining material of the bumper crossmember and, as a consequence, the tensile strength is reduced. As a result, a targeted deformation of the bumper crossmember in the middle region, in particular in the region of the tapered ends of the reinforcing plate, is also made possible, but the rigidity is maintained by way of the reinforcing plate and the front wall and rear wall of the bumper crossmembers.

Further advantages, features and properties of the present invention are the subject matter of the following description. Preferred design variants are shown in the diagrammatic figures. These serve for simple comprehension of the invention.

### IN THE FIGURES

FIG. 1 shows a bumper carrier arrangement according to the invention in a plan view,

FIG. 2 a to c show different cross-sectional views,

FIG. 3 a to c show alternative cross-sectional views,

FIG. 4 a to c in turn show alternative cross-sectional views,

FIG. 5 shows an alternative design variant of the bumper carrier arrangement in a plan view,

FIG. 6 a to d show different cross-sectional views than FIG. 5,

FIG. 7 a and b show a comparison of a bollard test of a bumper crossmember according to the prior art and according to the present invention, and

FIG. 8 shows one embodiment of soft zones on the bumper crossmember.

The same designations are used in the figures for identical or similar components, even if a repeated description is dispensed with for reasons of simplicity.

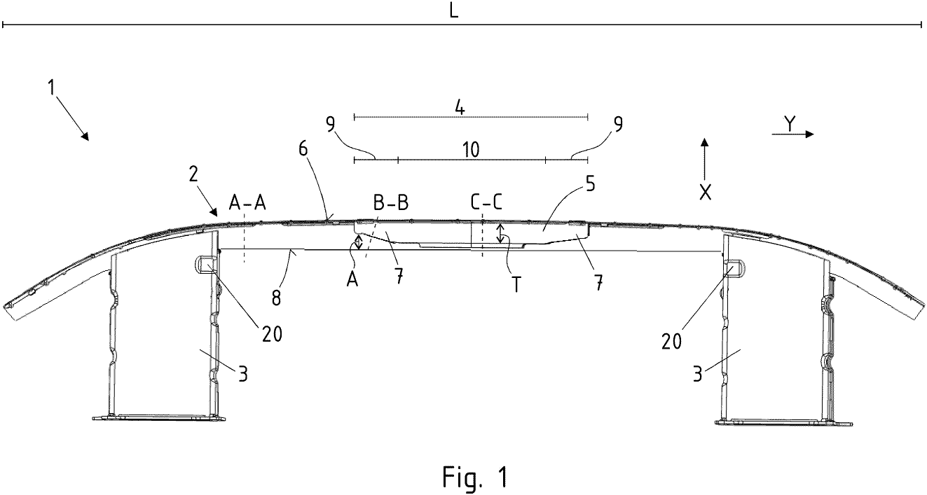

FIG. 1 shows a bumper crossmember arrangement 1 in a plan view. The bumper crossmember 2 is coupled to crash boxes 3. The bumper crossmember arrangement 1 is then coupled to a motor vehicle body (not shown in greater detail). The bumper crossmember 2 has a substantially curved course over its length. A middle length portion 4 can also be of substantially straight configuration.

In a middle length portion 4, a separate reinforcing plate 5 (shown here) is arranged in the bumper crossmember 2 and is coupled to the closing plate 13. The closing plate 13 with the reinforcing plate 5 is in turn coupled to the front wall of flanges of the bumper crossmember 2. The reinforcing plate 5, the closing plate 13 and the bumper crossmember 2 or the hollow profile of the bumper crossmember 2 are therefore three separate components. At the respective ends 7 of the reinforcing plate 5, the reinforcing plate 5 is of tapered configuration in its depth T. The depth T is oriented substantially in the motor vehicle longitudinal direction X. The middle length portion 4 has a longitudinal extent of approximately from 20% to 50%, in particular from 20% to 40% of the length L of the bumper crossmember 2. The length L relates to the motor vehicle transverse direction Y.

As a result of the tapered ends 7, the spacing A increases between a rear wall 8 of the bumper crossmember 2 and the respective tapered end 7. Over the entire longitudinal course, the reinforcing plate 5 particularly preferably has no direct contact with the rear wall 8 of the bumper crossmember 2.

Furthermore, a respective length portion is configured as a welded length portion 9, in which the reinforcing plate is welded to the closing plate 6. The welded length portions 9 are particularly preferably from 5% to 20%, in particular from 5% to 10% of the middle length portion 4. A non-welded length portion 10 which lies in between can therefore be deformed in the case of a crash, or the front wall 6 and the reinforcing plate could move relative to one another.

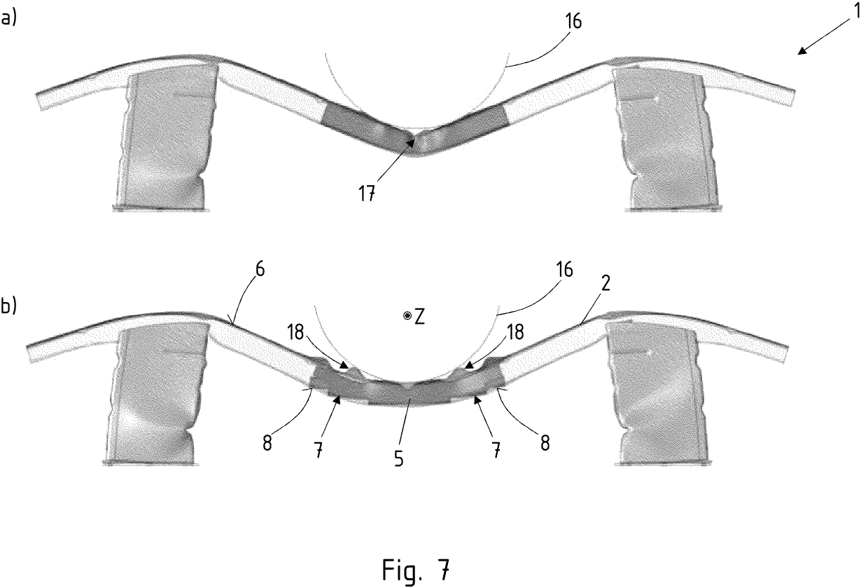

Furthermore, relieving elements 20 can particularly preferably be arranged on the side walls of the crash box 3 which face one another. The relieving elements 20 can be configured, for example, as a slit, slot, round hole or else an embossed portion. Targeted weakening of the crash boxes 3 takes place here. In the case of the crash shown in FIG. 7, the crash boxes 3 can therefore move toward one another, and therefore likewise promote a deflection of the bumper carrier 2, in particular according to FIG. 7b.

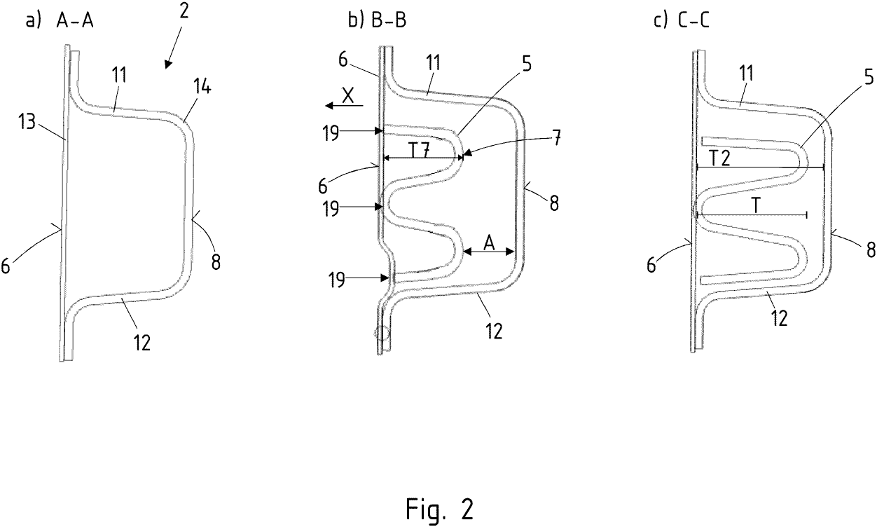

FIG. 2 a, b and c show respective crossover sectional views. It can be seen that the bumper crossmember 2 is a closed hollow profile in its cross section. This is configured from a top hat-shaped profile 14 which forms the rear wall 8, an upper flange 11 and a lower flange 12. The front wall 6 is configured by a closing plate 13. The closing plate 13 is coupled to the top hat profile 14, in particular flanges of the top hat profile. In accordance with the sectional lines from FIGS. 2b and 2c, the reinforcing plate 5 is shown in the hollow profile. FIG. 2b shows an end region 7 of the reinforcing plate 5. This has a depth T7 in the end region 7, which depth T7 is smaller than the depth T in the middle region. The depth T in the middle region is preferably configured to be from 70% to 100%, very particularly preferably from 80% to 95% and, in particular, approximately from 85% to 95% of the depth T2 of the bumper crossmember 2 in this region. Therefore, no direct contact with the rear wall 8 is configured. The depth T7 then decreases toward the end regions. The spacing A from the rear wall 8 increases. It is shown here that the W-shaped cross section of the reinforcing plate 5 decreases in its depth T from the middle region according to FIG. 2c toward the end regions 7 according to FIG. 2b. Welded joints 19 are configured, in particular, on all the bearing faces of the W-shaped profile on the front wall 6. According to FIG. 2c, no welded joint is configured, with the result that a relative displacement of the reinforcing plate 5 and the front wall in the case of a crash is also possible here, in particular in the motor vehicle transverse direction. The cross section is maintained, however.

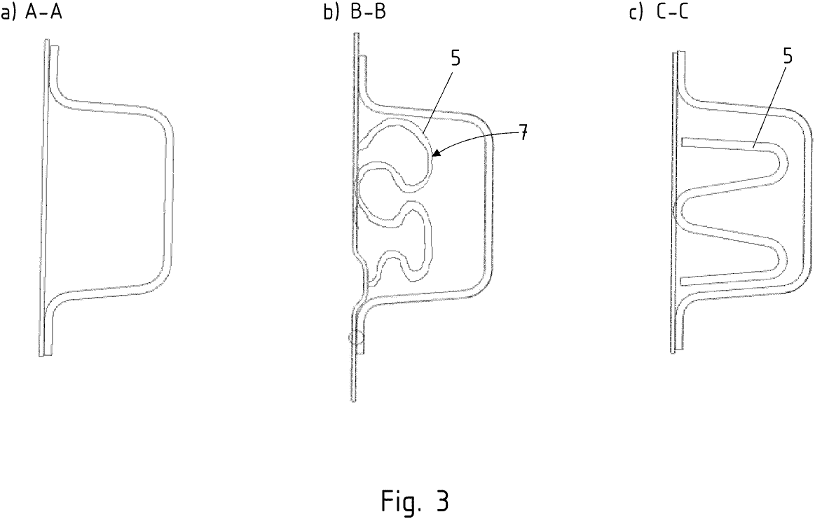

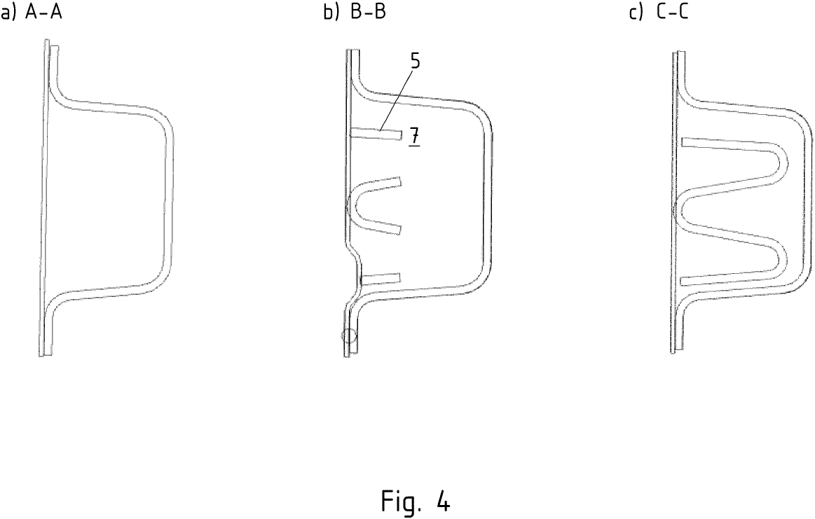

An alternative design variant is shown in FIG. 3 a, b and c. Here, the cross section of the reinforcing plate 5 according to FIG. 3b is flattened or stamped.

FIG. 4 a, b and c show an alternative design variant. Here, the end region 7 of the reinforcing plate 5 is cut, with the result that parts of the W-shaped cross section are cutaway or cut off.

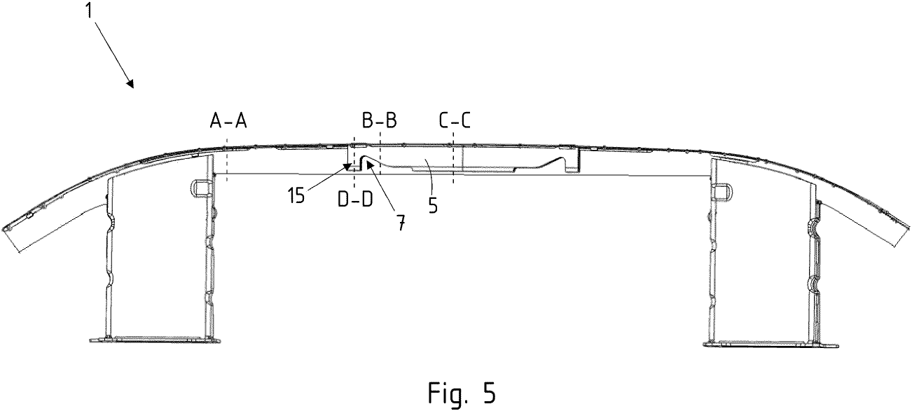

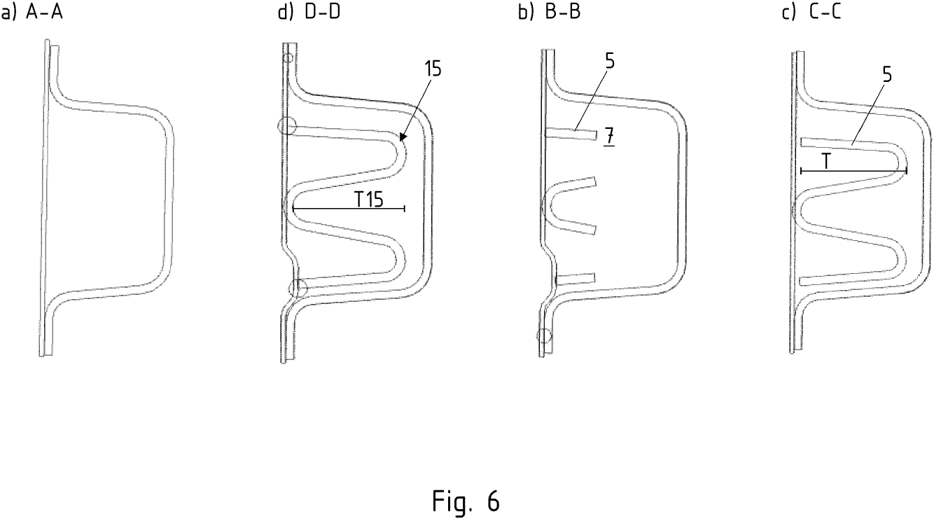

FIG. 5 shows an alternative design variant to FIG. 1. The ends 7 of the reinforcing profile 5 are adjoined by a further length portion which in turn has a depth T in the cross section of the reinforcing profile, which depth T is, in particular, increased in comparison with the tapered ends 7. This is shown in accordance with the sectional line D-D from FIG. 6d. Here, the depth T15 in turn corresponds to the depth T of the reinforcing plate 5 in the middle portion according to FIG. 6c. As a result, additional stiffening or reinforcement can be achieved for different crash scenarios, for example the RCAR bumper test.

The effect according to the invention is then shown in comparison in FIG. 7a and b. The bumper arrangement 2 is pressed in on account of a bollard or pole 16 or experiences bending or curved deformation. A kink point 17 is produced according to FIG. 7a. Either no reinforcing plate is used or a reinforcing plate 5 without tapering ends is used here.

According to FIG. 7b, the rear wall of the bumper crossmember 8 is deformed onto the tapered ends 7 of the reinforcing plate 5. As a result, buckling is avoided. The front wall 6 and the rear wall 8 can be displaced in each case relative to the reinforcing plate 5 and the motor vehicle transverse direction. This takes place on the rear wall 8 according to the principle of a tie rod. Slight bulges 18 result on the front wall 6, but no kink point or buckling is brought about. As a result, it is achieved according to the invention that a deformed deformation for energy dissipation is provided, without the bumper crossmember 2 piercing.

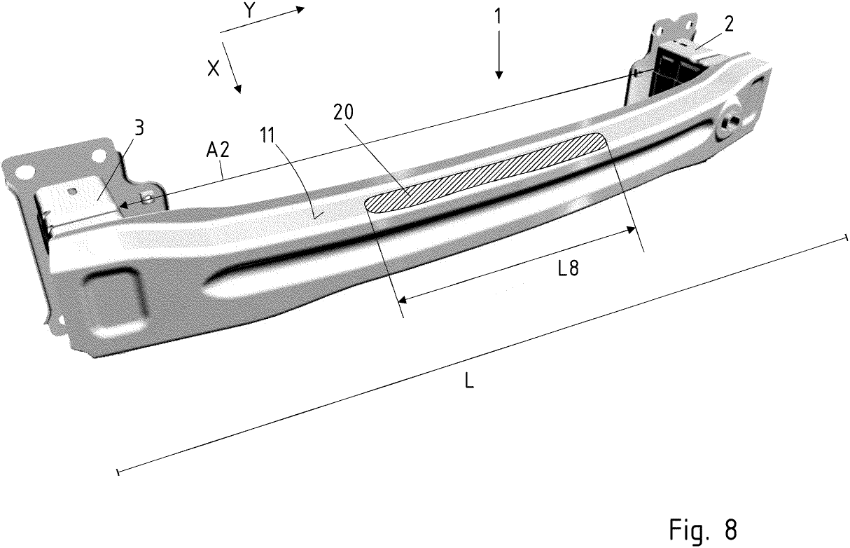

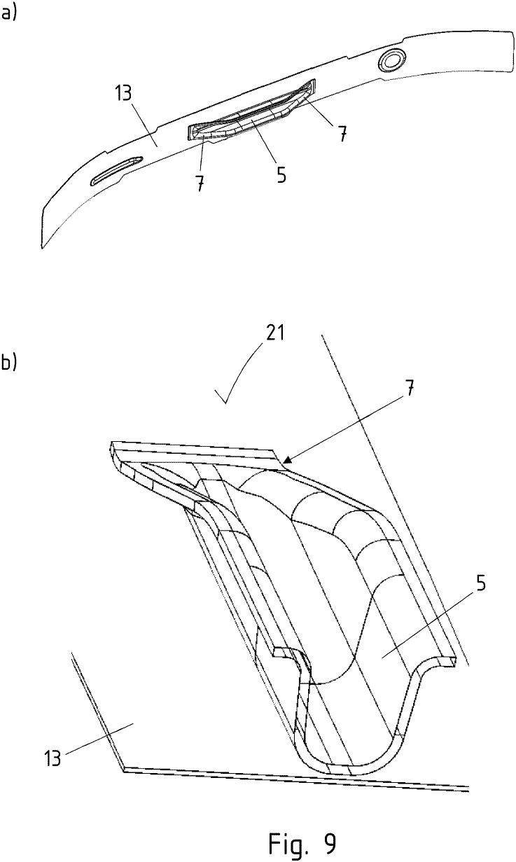

FIG. 8 shows a bumper arrangement 2. Here, a soft zone is configured in the upper flange 11 over a length L8 which particularly preferably corresponds to from 20% to 40% of the length of the spacing A2 between the crash boxes. In this soft zone, the material properties are changed; in particular, the tensile strength is reduced. This soft zone can also be present in the lower flange 12 (not shown in greater detail). The crash scenario according to FIG. 7b and, as a consequence, the bending around the pole are promoted by way of the presence of the soft zone.

FIG. 9a and b show a closing plate 13 in a rear view and a perspective detailed sectional view. The closing plate 13 has a curved course. The reinforcing plate 5 is arranged with its tapered ends 7 on a rear wall 21 of the closing plate 13 itself. In particular, the reinforcing plate 5 according to FIG. 9b is joined, in particular welded, at the tapered ends 7 to a rear wall 21 of the closing plate 5. Prepared in this way, the closing plate 13 can then be inserted into a top hat profile 14, and the closing plate 13 can in turn be joined thermally at least in length portions to flanges of the top hat profile 14. Optimum positioning and mounting of the reinforcing plate 5 take place as a result.

The ream forcing plate 5 is itself of top hat-shaped configuration at least in length portions in this case according to FIG. 9b. The reinforcing plate 5 can therefore be manufactured simply using pressing technology as a sheet metal component, in particular a steel sheet component.

### LIST OF DESIGNATIONS

1 - Bumper crossmember arrangement
2 - Bumper crossmember
3 - Crash box
4 - Middle length portion
5 - Reinforcing plate
6 - Front wall of 2
7 - End of 5
8 - Rear wall of 2
9 - Welded length portion
10 - Non-welded length portion
11 - Upper flange
12 - Lower flange
13 - Striking plate
14 - Top hat profile
15 - Further length portion
16 - Bollard/post
17 - Kink point
18 - Bulge
19 - Welded joint
20 - Relieving element
21 - Rear wall of 5

A - Spacing
T - Depth
T7 - Depth of 7
T15 - Depth of 15
L - Length of 2
X - Motor vehicle longitudinal direction
Y - Motor vehicle vertical direction

1. Bumper crossmember for a motor vehicle, which bumper crossmember extends in the motor vehicle transverse direction and has a hollow profile in cross section, in particular a rectangular cross section, characterized in that a reinforcing plate is inserted in a middle length portion, the depth of the reinforcing plate decreasing in the motor vehicle longitudinal direction toward the ends of the reinforcing plate.

2. Bumper crossmember according to claim 1, wherein the hollow profile is configured as a top hat profile, preferably with a striking plate.

3. Bumper crossmember according to claim 1, wherein the striking plate is arranged so as to point toward the front in the motor vehicle longitudinal direction.

4. Bumper crossmember according to claim 1, wherein the reinforcing plate is profiled in cross section, in particular is configured in a W-shaped manner.

5. Bumper crossmember according to claim 1, wherein the reinforcing plate extends in the motor vehicle transverse direction (Y) over a length (L) between 20 and 50%, preferably between 20 and 40% of the length of the bumper crossmember.

6. Bumper crossmember according to claim 1, wherein, in cross-section, the reinforcing plate has at least two limbs which are arranged in parallel or at an angle of no more than ±20° with respect to an upper flange and a lower flange of the bumper crossmember.

7. Bumper crossmember according to claim 1, wherein the tapering of the cross section of the reinforcing plate configures a greater spacing from a rear wall of the hollow profile of the crossmember, in relation to a middle portion.

8. Bumper crossmember according to claim 1, wherein the tapered ends of the reinforcing plate are produced by way of a cutting method, or in that the tapered ends of the reinforcing plate are produced by way of flattening or stamping, or the reinforcing plate is produced using press molding.

9. Bumper crossmember according to claim 1, wherein the reinforcing plate is coupled, in particular welded, to the front wall in length portions.

10. Bumper crossmember according to claim 1, wherein the crossmember has a soft zone in a middle length portion in an upper flange and/or in a lower flange.

11. Bumper crossmember according to claim 1, wherein the bumper crossmember is configured by way of a top hat profile with a closing plate which lies at the front, the reinforcing plate being coupled to the closing plate.

12. Bumper crossmember arrangement, wherein it has a bumper crossmember with the features of at least claim 1, which bumper crossmember is coupled to crash boxes.

13. Bumper crossmember arrangement according to claim 12, wherein the crash boxes have relieving elements in a front region on their sides which point toward one another.
